(19) United States
(12) Patent Application Publication
(10) Pub. No.: US 2013/0084052 A1
(43) Pub. Date: Apr. 4, 2013

(54) ELECTRONIC DEVICE AND NETWORK ACCESS MODULE

(71) Applicants: Liang-Wei Huang, Hsinchu City (TW); Tzu-Han Hsu, Kaohsiung City (TW); Ching-Yao Su, Taichung City (TW); Hsuan-Ting Ho, Taichung City (TW)

(72) Inventors: Liang-Wei Huang, Hsinchu City (TW); Tzu-Han Hsu, Kaohsiung City (TW); Ching-Yao Su, Taichung City (TW); Hsuan-Ting Ho, Taichung City (TW)

(21) Appl. No.: 13/607,828

(22) Filed: Sep. 10, 2012

(30) Foreign Application Priority Data
Sep. 30, 2011 (TW) 100135645

(51) Int. Cl. H04N 5/775; H04N 5/765

(52) U.S. Cl. 386/230; 386/231; 386/E05.07; 386/E05.002

(57) ABSTRACT

The disclosure provides an electronic device and a network access module. The electronic device comprises: a multimedia processing module and a network access module. The multi-media processing module comprises a first network control circuit, and the network access module comprises: a second network control circuit, a third network control circuit, at least a fourth network control circuit, a network transmission unit, and a multiplexer. The multiplexer is utilized for selecting at least a multimedia connecting port from a plurality of multimedia connecting ports to connect to the at least a fourth network control circuit, so as to make at least a multimedia device connected to the at least a multimedia connecting port to connect to an external network and access the external network via the at least a fourth network control circuit, the network transmission unit, the third network control circuit, and the network connecting port.

### BACKGROUND OF THE INVENTION

1. Field of the Invention

The present invention relates to an electronic device and a network access module.

2. Description of the Prior Art

Please refer to FIG. 1. FIG. 1 shows a conventional high definition multimedia interface (HDMI) system application. As shown in FIG. 1, an LCD TV 100 comprises 4 HDMI connecting ports (not shown) respectively connected to 4 multimedia devices 102, 104, 106, 108 (such as PS3, XBOX, DVD player and multimedia externally connecting HD player). If all the LCD TV 100 and the 4 multimedia devices 102, 104, 106, 108 need to connect to internet, the LCD TV 100 and the 4 multimedia devices 102, 104, 106, 108 are required to be independently connected to an external network 110, respectively, and thus the conventional high definition multimedia interface system application requires 5 Ethernet cables in total.

The HDMI version 1.4 has a new function named HDMI Ethernet and Audio return Channel (HEAC), where the HEAC function can make a network receiver to transmit/receive HDMI Ethernet Channel (HEC) data signals and Audio Return Channel (ARC) data signals simultaneously. Therefore, complex home network wiring can be simplified. Please refer to FIG. 2. FIG. 2 shows an HDMI 1.4 system application. As shown in FIG. 2, an LCD TV 200 comprises 4 HDMI connecting ports (not shown) respectively connected to 4 multimedia devices 202, 204, 206, 208 (such as PS3, XBOX, DVD player and multimedia externally connecting HD player). If all the LCD TV 200 and the 4 multimedia devices 202, 204, 206, 208 need to connect to internet, the LCD TV 200 and the 4 multimedia devices 202, 204, 206, 208 can be connected to an external network 210 via the LCD TV 200. However, a 6 port switch is required to be implemented in the LCD TV 200. Please refer to FIG. 3. FIG. 3 shows a simplified block diagram of the LCD TV 200. As shown in FIG. 3, the LCD TV 200 comprises a TV chip 310 and a network chip 320, and the TV chip 310 comprises: a media access control (MAC) layer control circuit 312, and the network chip 320 comprises a MAC layer control circuit 321, 5 MAC/PHY layer control circuit 322, 324, 326, 328, 330, and a 6 port switch 332.

However, although the LCD TV 200 is connected to 4 multimedia devices 202, 204, 206, 208 (such as PS3, XBOX, DVD player and multimedia externally connecting HD player), only one of the 4 multimedia devices 202, 204, 206, 208 can be used at one time. For example, when the user plays the PS3, the user can not use the DVD player at the same time. Similarly, when the user uses the internet, the user only can use one of the 4 multimedia devices to connect to the external network 210 at one time due to there is only one TV monitor. In this way, the 6 port switch 332 implemented in the LCD TV 200 of the prior art is a waste, and it increases hardware cost.

### SUMMARY OF THE INVENTION

It is therefore one of the objectives of the present invention to provide an electronic device and a network access module, and the electronic device and the network access module can utilize a multiplexer to switch network connection to reduce cost, so as to solve the above problem.

In accordance with an embodiment of the present invention, an electronic device is disclosed. The electronic device comprises: a multimedia processing module and a network access module. The multimedia processing module is utilized for controlling the electronic device to perform a multimedia playing operation, and the multimedia processing module comprises a first network control circuit. The multimedia processing module comprises: a second network control circuit, a third network control circuit, at least a fourth network control circuit, a network transmission unit, and a multiplexer. The second network control circuit is coupled to the first network control circuit. The third network control circuit is coupled to the second network control circuit, and coupled to an external network via a network connecting port. The least a fourth network control circuit is coupled to the third network control circuit. The network transmission unit is coupled between the second network control circuit, the third network control circuit, and the at least a fourth network control circuit, and utilized for transmitting at least a network data signal between the second network control circuit, the third network control circuit, and the at least a fourth network control circuit. The multiplexer is coupled between the at least a fourth network control circuit and a plurality of multimedia connecting ports, and utilized for selecting at least a multimedia connecting port from the multimedia connecting ports to connect to the at least a fourth network control circuit, so as to make at least a multimedia device connected to the at least a multimedia connecting port to connect to an external network and access the external network via the at least a fourth network control circuit, the network transmission unit, the third network control circuit, and the network connecting port.

In accordance with an embodiment of the present invention, a network access module is disclosed. The network access module comprises: a first network control circuit, at least a second network control circuit, a network transmission unit, and a multiplexer. The first network control circuit is coupled to an external network via a network connecting port. The least a second network control circuit is coupled to the first network control circuit. The network transmission unit is coupled between the first network control circuit and the at least a second network control circuit, and utilized for transmitting at least a network data signal between the first network control circuit and the at least a second network control circuit. The multiplexer is coupled between the at least a second network control circuit and a plurality of multimedia connecting ports, and utilized for selecting at least a multimedia connecting port from the multimedia connecting ports to connect to the at least a second network control circuit, so as to make at least a multimedia device connected to the at least a multimedia connecting port to connect to an external network and access the external network via the at least a second network control circuit, the network transmission unit, the first network control circuit, and the network connecting port, wherein the multimedia connecting ports are high definition multimedia interface (HDMI) connecting ports utilized for transmitting HDMI ethernet channel (HEC) data signals.

Briefly summarized, the electronic device and the network access module disclosed by the present invention can utilize a multiplexer to switch network connection to reduce cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a conventional high definition multimedia interface (HDMI) system application.

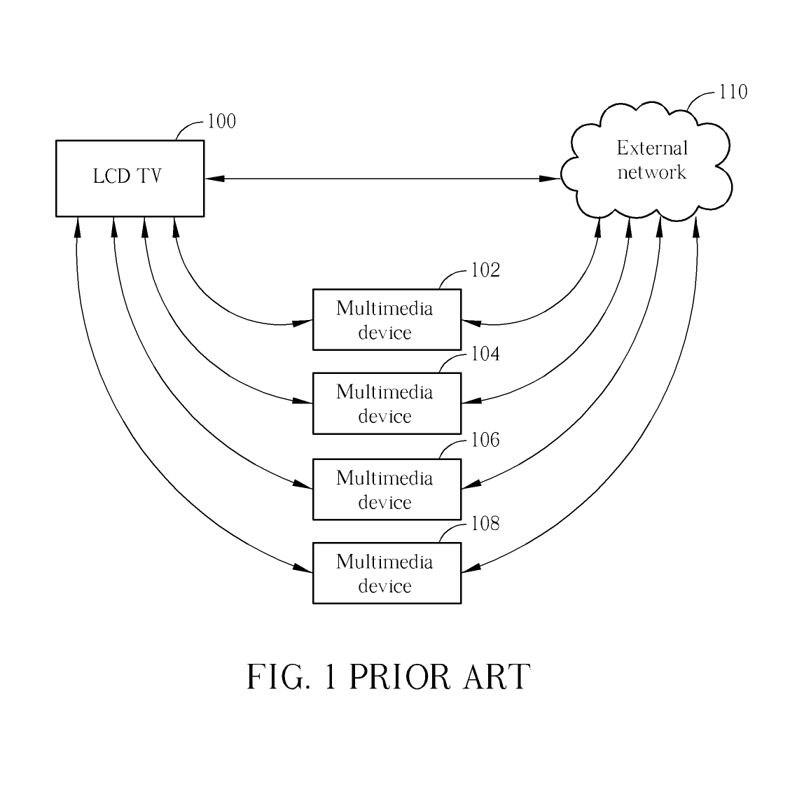

FIG. 2 shows an HDMI 1.4 system application.

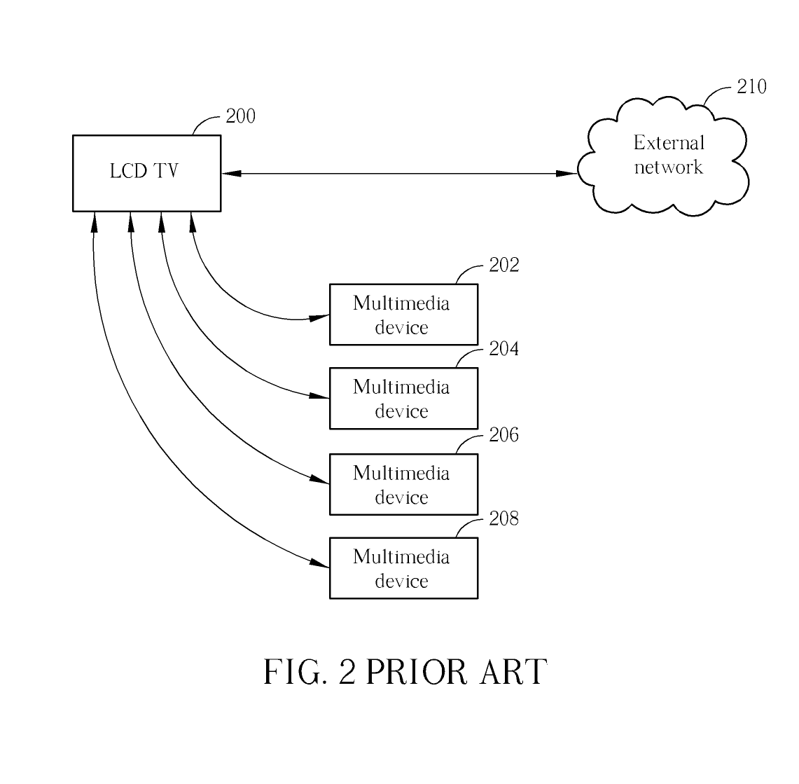

FIG. 3 shows a simplified block diagram of the LCD TV in FIG. 2.

FIG. 4 shows a simplified block diagram of an electronic device in accordance with an embodiment of the present invention

FIG. 5 shows a simplified block diagram of an electronic device in accordance with another embodiment of the present invention

FIG. 6 shows a simplified block diagram of a network access module in accordance with an embodiment of the present invention

FIG. 7 shows a simplified block diagram of a network access module in accordance with another embodiment of the present invention

### DETAILED DESCRIPTION

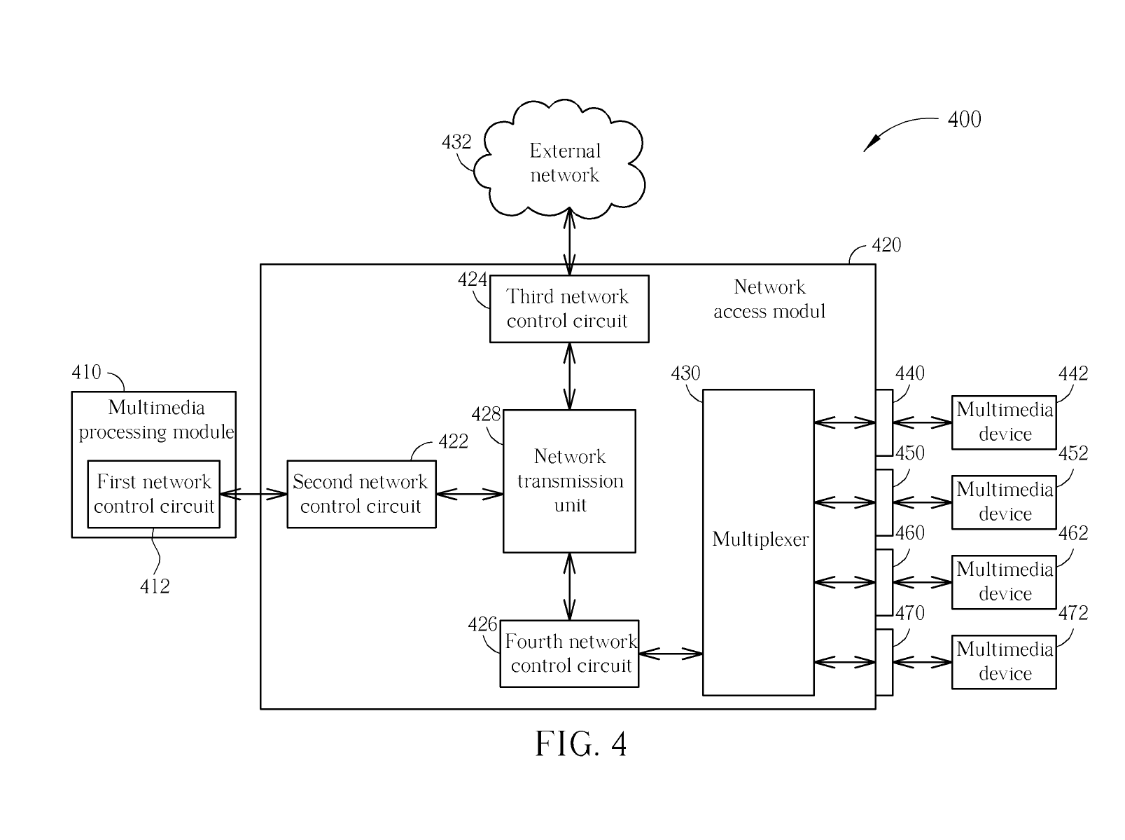

Please refer to FIG. 4. FIG. 4 shows a simplified block diagram of an electronic device 400 in accordance with an embodiment of the present invention, wherein the electronic device 400 can be a TV or a display device with speaker(s). As shown in FIG. 4, the electronic device 400 comprises: a multimedia processing module 410 and a network access module 420, wherein the multimedia processing module 410 and the network access module 420 are both hardwares. The multimedia processing module 410 is utilized for controlling the electronic device 400 to perform a multimedia playing operation, and the multimedia processing module 410 comprises a first network control circuit 412. The multimedia processing module 410 comprises: a second network control circuit 422, a third network control circuit 424, a fourth network control circuit 426, a network transmission unit 428, and a multiplexer 430. The second network control circuit 422 is coupled to the first network control circuit 412. The third network control circuit 424 is coupled to the second network control circuit 422, and coupled to an external network 432 via a network connecting port (not shown). The fourth network control circuit 426 is coupled to the third network control circuit 424, wherein the first network control circuit 412 and the second network control circuit 422 can be media access control (MAC) layer control circuits, and the third network control circuit 424 and the fourth network control circuit 426 can be MAC/physical (PHY) layer control circuits. Please note that the above embodiment is only for an illustrative purpose and is not meant to be a limitation of the present invention. For example, the first network control circuit 412 and the second network control circuit 422 also can be MAC/PHY layer control circuits according to other different design requirements and specific conditions.

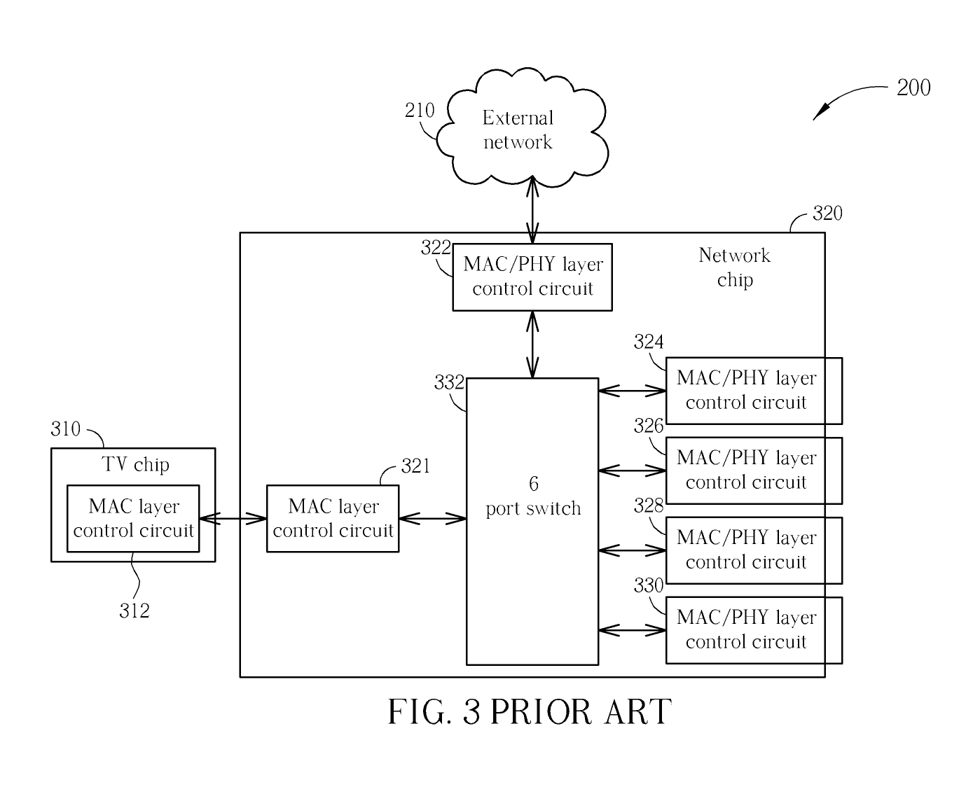

The network transmission unit 428 is coupled between the second network control circuit 422, the third network control circuit 424, and the fourth network control circuit 426, and utilized for transmitting at least a network data signal between the second network control circuit 422, the third network control circuit 424, and the fourth network control circuit 426, wherein the network transmission unit 428 is only required to have 3 connecting ports, and the network transmission unit 428 can be a switch, a router, a hub, or a gateway. The multiplexer 430 is coupled between the fourth network control circuit 426 and 4 multimedia connecting ports 440, 450, 460, 470, and the 4 multimedia connecting ports 440, 450, 460, 470 are coupled to 4 multimedia devices 442, 452, 462, 472, respectively. The multiplexer 430 is a 1 to 4 multiplexer (1 to 4 MUX), and utilized for selecting a multimedia connecting port (such as the multimedia connecting port 460) from the multimedia connecting ports 440, 450, 460, 470 to connect to the fourth network control circuit 426, so as to make multimedia device (such as the multimedia device 462) connected to the multimedia connecting port (such as the multimedia connecting port 460) be able to connect to the external network 432 and access the external network 432 via the fourth network control circuit 426, the network transmission unit 428, the third network control circuit 424, and the network connecting port, wherein the multimedia connecting ports 440, 450, 460, 470 are high definition multimedia interface (HDMI) connecting ports utilized for transmitting HDMI ethernet channel (HEC) data signals, and the multimedia devices 442, 452, 462, 472 can be a electronic game device, a multimedia storage device, a multimedia playing device, a personal computer, or a notebook computer, respectively. In addition, the multimedia processing module 410 can be further utilized for controlling the multiplexer 430 to select a multimedia connecting port (such as the multimedia connecting port 460) from the multimedia connecting ports 440, 450, 460, 470 to connect to the fourth network control circuit 426 (that is, the user can control the multiplexer 430 via a remote controller or control buttons of the TV), so as to make multimedia device (such as the multimedia device 462) connected to the multimedia connecting port (such as the multimedia connecting port 460) be able to connect to the external network 432 and access the external network 432 via the fourth network control circuit 426, the network transmission unit 428, the third network control circuit 424, and the network connecting port. In other words, compared with the prior art in FIG. 3, this embodiment can reduce the number of the MAC/PHY layer control circuits from 5 to 2 by only adding a multiplexer 430 in the analog front end (AFE), and this embodiment only requires a network transmission unit (such as a switch, a router, a hub, or a gateway) with 3 connecting ports. On the other hand, the prior art in FIG. 3 requires a network transmission unit with 6 connecting ports. Thus, the present invention can utilize a multiplexer to switch network connection to reduce cost.

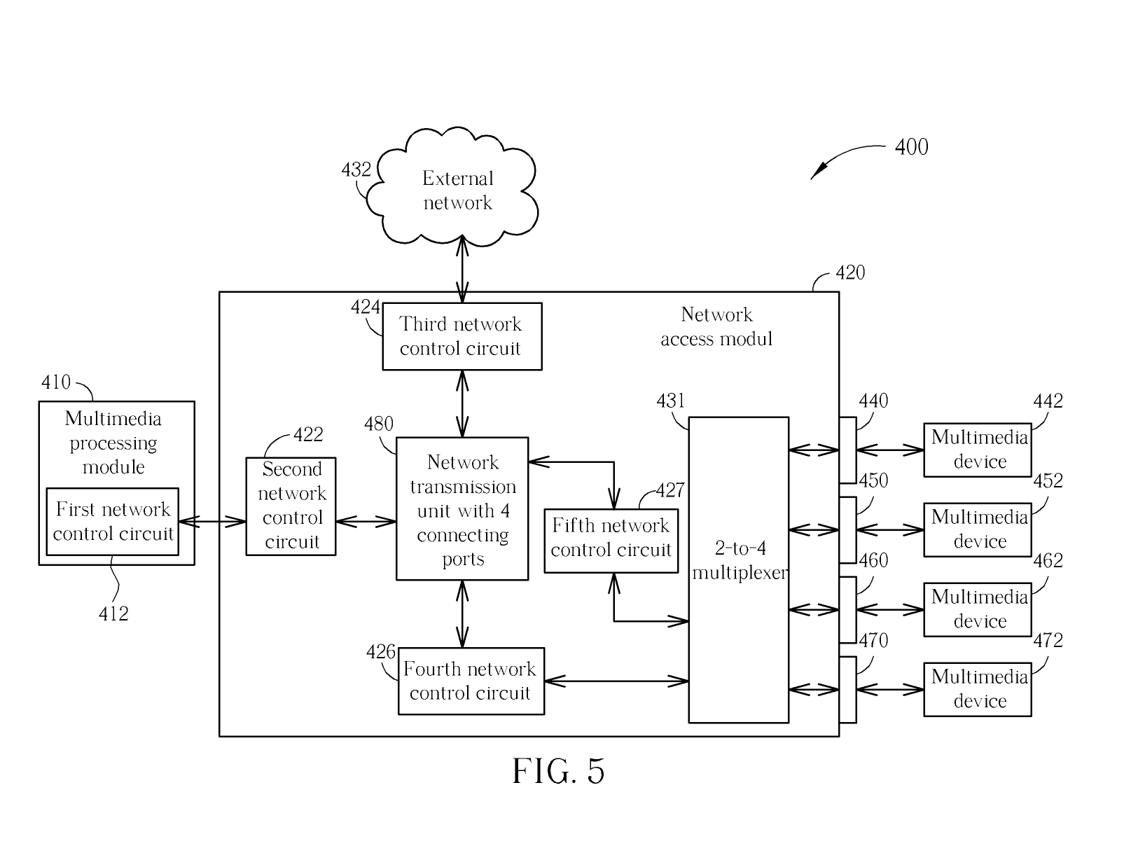

In addition, please note that the above embodiment is only for an illustrative purpose and is not meant to be a limitation of the present invention. For example, the multimedia processing module 410 in FIG. 4 can further comprise a fifth network control circuit 427, and the network transmission unit 428 can be replaced by a network transmission unit 480 with 4 connecting ports, and the multiplexer 430 can be replaced by a 2 to 4 multiplexer 431 (2 to 4 MUX), as shown in FIG. 5. In any case, various modifications and alterations of the device and method should fall into the disclosed scope of the present invention as long as the performances and functions of using a multiplexer to switch network connection disclosed by the present invention can be attained.

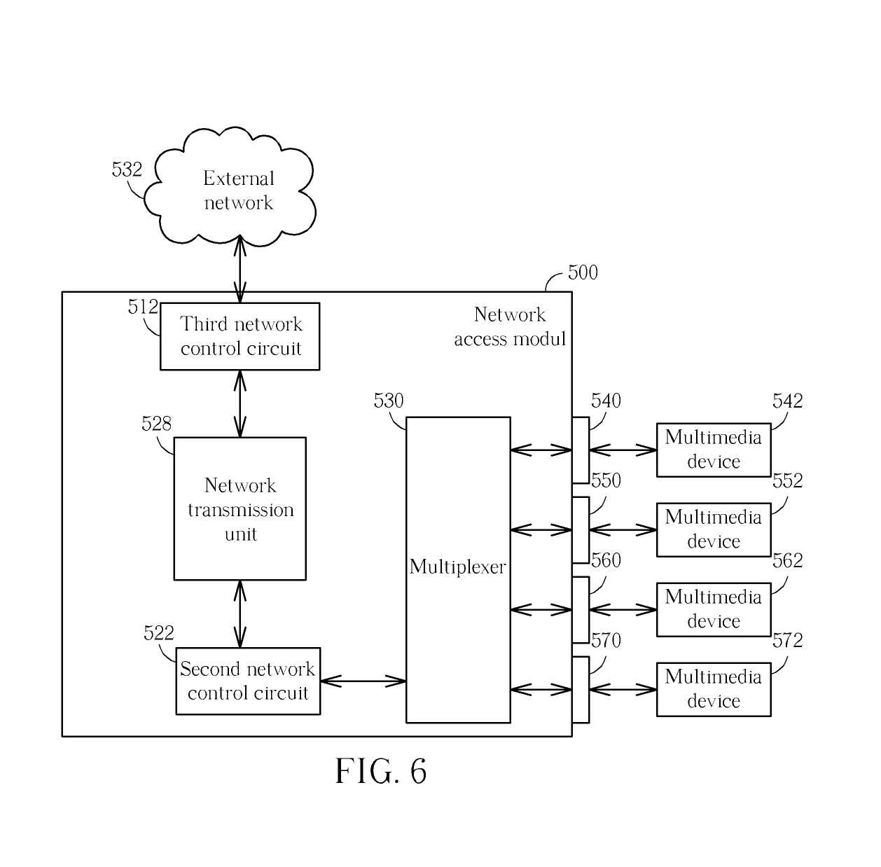

Please refer to FIG. 6. FIG. 6 shows a simplified block diagram of a network access module 500 in accordance with an embodiment of the present invention, wherein the network access module 500 is a hardware. As shown in FIG. 6, the network access module 500 comprises: a first network control circuit 512, second network control circuit 522, a network transmission unit 528, and a multiplexer 530. The first network control circuit 512 is coupled to an external network 532 via a network connecting port (not shown), and the second network control circuit 522 is coupled to the first network control circuit 512, wherein the first network control circuit 512 and the second network control circuit 522 can be MAC/physical (PHY) layer control circuits.

The network transmission unit 528 is coupled between the first network control circuit 512 and the second network control circuit 522, and utilized for transmitting at least a network data signal between the first network control circuit 512 and the second network control circuit 522, wherein the network transmission unit 528 is only required to have 2 connecting ports, and the network transmission unit 528 can be a switch, a router, a hub, or a gateway. The multiplexer 530 is coupled between the fourth network control circuit 526 and 4 multimedia connecting ports 540, 550, 560, 570, and the 4 multimedia connecting ports 540, 550, 560, 570 are coupled to 4 multimedia devices 542, 552, 562, 572, respectively. The multiplexer 530 is a 1 to 4 multiplexer (1 to 4 MUX), and utilized for selecting a multimedia connecting port (such as the multimedia connecting port 560) from the multimedia connecting ports 550, 550, 560, 570 to connect to the second network control circuit 522, so as to make multimedia device (such as the multimedia device 562) connected to the multimedia connecting port (such as the multimedia connecting port 560) be able to connect to the external network 532 and access the external network 532 via the second network control circuit 522, the network transmission unit 528, the first network control circuit 512, and the network connecting port, wherein the multimedia connecting ports 550, 550, 560, 570 are high definition multimedia interface (HDMI) connecting ports utilized for transmitting HDMI ethernet channel (HEC) data signals, and the multimedia devices 552, 552, 562, 572 can be a electronic game device, a multimedia storage device, a multimedia playing device, a personal computer, or a notebook computer, respectively. Similarly, compared with the prior art in FIG. 3, this embodiment can reduce the number of the MAC/PHY layer control circuits from 5 to 2 by only adding a multiplexer 530 in the analog front end (AFE), and this embodiment only requires a network transmission unit (such as a switch, a router, a hub, or a gateway) with 2 connecting ports. On the other hand, the prior art in FIG. 3 requires a network transmission unit with 6 connecting ports. Thus, the present invention can utilize a multiplexer to switch network connection to reduce cost.

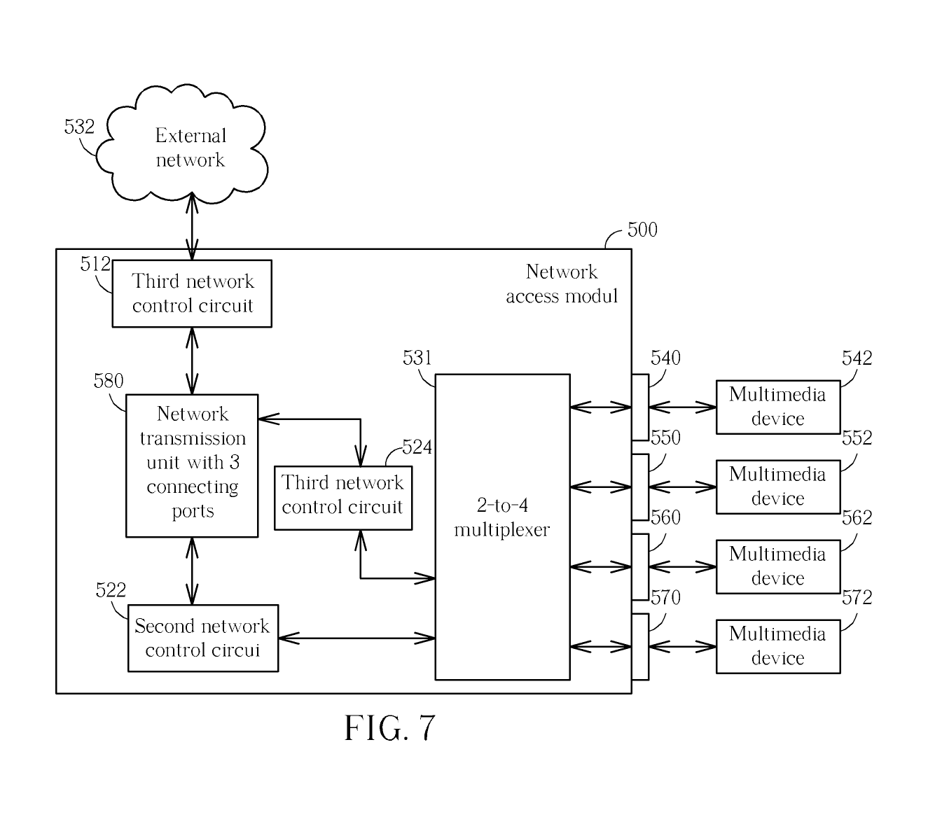

In addition, please note that the above embodiment is only for an illustrative purpose and is not meant to be a limitation of the present invention. For example, the multimedia processing module 510 in FIG. 6 can further comprise a third network control circuit 524, and the network transmission unit 528 can be replaced by a network transmission unit 580 with 3 connecting ports, and the multiplexer 530 can be replaced by a 2 to 4 multiplexer 531 (2 to 5 MUX), as shown in FIG. 7. In any case, various modifications and alterations of the device and method should fall into the disclosed scope of the present invention as long as the performances and functions of using a multiplexer to switch network connection disclosed by the present invention can be attained.

Briefly summarized, the electronic device and the network access module disclosed by the present invention can utilize a multiplexer to switch network connection to reduce cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a multimedia processing module, for controlling the electronic device to perform a multimedia playing operation, and the multimedia processing module comprising:
a first network control circuit; and
a network access module, comprising:
a second network control circuit, coupled to the first network control circuit;
a third network control circuit, coupled to the second network control circuit, and coupled to an external network via a network connecting port;
at least a fourth network control circuit, coupled to the third network control circuit;
a network transmission unit, coupled between the second network control circuit, the third network control circuit, and the at least a fourth network control circuit, for transmitting at least a network data signal between the second network control circuit, the third network control circuit, and the at least a fourth network control circuit; and
a multiplexer, coupled between the at least a fourth network control circuit and a plurality of multimedia connecting ports, utilized for selecting at least a multimedia connecting port from the multimedia connecting ports to connect to the at least a fourth network control circuit, so as to make at least a multimedia device connected to the at least a multimedia connecting port to connect to an external network and access the external network via the at least a fourth network control circuit, the network transmission unit, the third network control circuit, and the network connecting port.

2. The electronic device of claim 1, wherein the first network control circuit is a media access control (MAC) layer control circuit, and the second network control circuit, the third network control circuit, and the at least a fourth network control circuit are MAC/physical (PHY) layer control circuits.

3. The electronic device of claim 1, wherein the multimedia processing module is further utilized for controlling the multiplexer to select at least a multimedia connecting port from the multimedia connecting ports to connect to the at least a fourth network control circuit.

4. The electronic device of claim 1, wherein the multimedia connecting ports are high definition multimedia interface (HDMI) connecting ports utilized for transmitting HDMI ethernet channel (HEC) data signals.

5. The electronic device of claim 1, wherein the electronic device is a TV or a display device with speaker(s).

6. The electronic device of claim 1, wherein the at least a multimedia device is a electronic game device, a multimedia storage device, a multimedia playing device, a personal computer, or a notebook computer.

7. The electronic device of claim 1, wherein the network transmission unit is a switch, a router, a hub, or a gateway.

8. A network access module, comprising:
a first network control circuit, coupled to an external network via a network connecting port;
at least a second network control circuit, coupled to the first network control circuit;
a network transmission unit, coupled between the first network control circuit and the at least a second network control circuit, for transmitting at least a network data signal between the first network control circuit and the at least a second network control circuit; and
a multiplexer, coupled between the at least a second network control circuit and a plurality of multimedia connecting ports, utilized for selecting at least a multimedia connecting port from the multimedia connecting ports to connect to the at least a second network control circuit, so as to make at least a multimedia device connected to the at least a multimedia connecting port to connect to an external network and access the external network via the at least a second network control circuit, the network transmission unit, the first network control circuit, and the network connecting port;
wherein the multimedia connecting ports are high definition multimedia interface (HDMI) connecting ports utilized for transmitting HDMI ethernet channel (HEC) data signals.

9. The electronic device of claim 8, wherein the first network control circuit and the at least a second network control circuit are MAC/physical (PHY) layer control circuits.

10. The electronic device of claim 8, wherein the at least a multimedia device is a electronic game device, a multimedia storage device, a multimedia playing device, a personal computer, or a notebook computer.

11. The electronic device of claim 8, wherein the network transmission unit is a switch, a router, a hub, or a gateway.
